(19) United States
(12) Patent Application Publication
(10) Pub. No.: US 2010/0199269 A1
(43) Pub. Date: Aug. 5, 2010

(54) PROGRAM OPTIMIZATION DEVICE AND PROGRAM OPTIMIZATION METHOD

(75) Inventors: Dai Hattori, Shiga (JP); Tomoo Hamada, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/668,967

(22) PCT Filed: Oct. 8, 2008
(86) PCT No.: PCT/JP2008/002843

§ 371 Date: Jan. 13, 2010

(30) Foreign Application Priority Data
Feb. 5, 2008 (JP) 2008-024680

(51) Int. Cl. G06F 9/45

(52) U.S. Cl. 717/146; 717/159

(57) ABSTRACT

A program optimization device which, when optimizing a program, performs optimization depending on characteristics of data to be processed by the program without having to execute the program before the optimization, includes: an intermediate code conversion unit that converts an input program to be optimized, into an intermediate code; a variable value setting unit that sets a possible value of a variable according to externally provided information; a node value calculation unit that calculates a possible value of a node included in the intermediate code according to the value set by the variable value setting unit; an intermediate code optimization unit that optimizes the intermediate code according to the value calculated by the node value calculation unit; and an output program conversion unit that converts the intermediate code optimized by the intermediate code optimization unit, to an output program.

### TECHNICAL FIELD

The present invention relates to optimization devices and optimization methods for optimizing a computer program, and in particular to an optimization device and an optimization method for optimizing a computer program based on a nature of data during execution.

### BACKGROUND ART

In general, when compiling a source program written in a programming language, an operation of the source program is analyzed to optimize the source program.

Generally known optimization methods include, for example, constant folding, dead code elimination, and so on. These optimization methods include replacing calculation that can be calculated at the time of compiling with a calculation result, or deleting, from a program that has been compiled, a code and the like which are unreachable at the time of executing the program. Program optimization has conventionally been conducted in accordance with the above-described methods.

In addition, as disclosed by Non-Patent Reference 1, there is a method with which the range of analysis for a source program is expanded and interprocedural constant propagation is performed according to a result of an interprocedural analysis to perform calculation at the time of compiling as much as possible, thereby improving processing time during the execution.

Further, as disclosed by Patent Reference 1, there is a method with which frequency of appearance of a possible value of a variable is calculated by executing a program, and a specialized program is generated when the variable is a specified value, and operations for improving processing time during the execution is performed when the variable is a specified value with high frequency of appearance.

### Patent Reference 1: Japanese Unexamined Patent Application

### Publication No. 2002-259135

### Non-Patent Reference 1: Paul R. Carini, M. Hind, “Flow-Sensitive Interprocedural Constant Propagation”, The ACM SIGPLAN Conference on Programming Language Design and Implementation, 1995

### DISCLOSURE OF INVENTION

### Problems that Invention is to Solve

However, the optimization methods as described above are based on the result of analyzing a source program. For that reason, it is not possible to perform optimization depending on characteristics of data to be processed through execution of the program. In addition, even when performing optimization depending on characteristics of data, it is necessary to execute the program prior to the optimization.

The present invention has been conceived to present a solution to the above-stated problems and aims to provide a program optimization device that allows optimization that does not require executing a program prior to the optimization and depends on characteristics of data to be processed through execution of the program.

### Means to Solve the Problems

According to an aspect of the present invention, there is provided a program optimization device which optimizes an input program written in a programming language, the device including: an intermediate code conversion unit configured to convert the input program into an intermediate code; a variable value setting unit configured to obtain, from externally provided information, a possible value of a variable to be used in the input program, and to set the obtained possible value of the variable, on the intermediate code; an intermediate code optimization unit configured to optimize the intermediate code according to the set possible value of the variable; and an output program conversion unit configured to convert the intermediate code optimized by the intermediate code optimization unit into an output program written in a predetermined format.

The above structure allows optimizing an intermediate code according to a possible value of a variable which is used in an input program and obtained in advance. As described above, it is possible to perform optimization depending on characteristics of data to be processed by executing a program, by setting the characteristics of data to be processed by executing the program as a possible value of a variable.

More specifically the variable value setting unit may obtain the possible value of the variable to be used in the input program with an input by a user, and may set the obtained possible value of the variable, on the intermediate code.

Further, the variable value setting unit may obtain the possible value of the variable to be used in the input program from a directive written in the input program, and may set the obtained possible value of the variable, on the intermediate code.

Further, the variable value setting unit may obtain the possible value of the variable to be used in the input program from a predetermined file, and may set the obtained possible value of a variable on the intermediate code.

Further, the intermediate code optimization unit may replace, when the intermediate code is represented in a tree structure, a node that has only one possible value among a plurality of nodes included in the intermediate code, with a node that indicates a constant.

Further, the intermediate code optimization unit may delete from the intermediate code, when the intermediate code is represented in a tree structure, a branch depending on a value not included in the possible value of the node that represents a conditional branch.

Since a possible value of a variable in an input program is specified, it is also possible to generate an output program with a small program size, by using a value calculated from the possible value of the variable to replace the variable with a constant in the case where a result of the calculation is invariably a fixed value or to delete a redundant branch.

Further, the intermediate code optimization unit, when the intermediate code is represented in a tree structure, may convert a node that includes a variable node indicating a variable that has a plurality of possible values into a plurality of nodes each of which includes the variable node that branches according to the possible value, and may replace the variable node included in each of the plurality of nodes resulting from the conversion, with a constant node that indicates the possible value used as a condition for branching.

Since a possible value of a variable in an input program is specified, it is also possible to increase the number of replacement with a constant even with a small number of branches, by using a value calculated from a possible value of a variable, thereby increasing a possibility of higher execution speed.

Further, the intermediate code optimization unit, when the intermediate code is represented in a tree structure, may calculate a possible value of a node from the possible value of the variable, and may optimize the intermediate code according to the possible value of the node.

According to another aspect of the present invention, there is provided a program optimization device which optimizes an input program written in a programming language, in which the device may include: an intermediate code conversion unit configured to convert the input program into an intermediate code; a variable value setting unit configured to obtain, from externally provided information, a possible value of a variable to be used in the input program, and to set the obtained possible value of the variable, on a node in a tree structure representing the intermediate code; an intermediate code optimization unit configured to optimize the intermediate code according to the possible value of the node; and an output program conversion unit configured to convert the intermediate code optimized by the intermediate code optimization unit into an output program written in a predetermined format.

The above structure allows optimizing an intermediate code according to a possible value of a variable which is used in an input program and obtained in advance. As described above, it is possible to perform optimization depending on characteristics of data to be processed by executing a program, by setting the characteristics of data to be processed by executing the program as a possible value of a variable.

Further, the intermediate code optimization unit may replace, when the intermediate code is represented in the tree structure, a node that has only one possible value among a plurality of nodes included in the intermediate code, with a node that indicates a constant

Further, the intermediate code optimization unit may delete from the intermediate code, when the intermediate code is represented in the tree structure, a branch depending on a value not included in a possible value of the node that represents a conditional branch.

Since a possible value of a variable in an input program is specified, it is also possible to generate an output program with a small program size, by using a value calculated from the possible value of the variable to replace the variable with a constant in the case where a result of the calculation is invariably a fixed value or to delete a redundant branch.

Further, the intermediate code optimization unit, may convert, when the intermediate code is represented in the tree structure, a node that includes a variable node indicating a variable that has a plurality of possible values into a plurality of nodes each of which includes the variable node that branches according to a possible value, and may replace the variable node included in each of the plurality of nodes resulting from the conversion, with a constant node that indicates the possible value used as the a condition for branching.

Since a possible value of a variable in an input program is specified, it is also possible to increase the number of replacement with a constant even with a small number of branches, by using a value calculated from a possible value of a variable, thereby increasing a possibility of higher execution speed.

Further, the variable value setting unit may obtain the possible value of the variable to be used in the input program with an input by a user, and may set the obtained possible value of a variable, on the node of the intermediate code.

Further, the variable value setting unit may obtain the possible value of the variable to be used in the input program from a directive written in the input program, and may set the obtained possible value of the variable, on the node of the intermediate code.

Further, the variable value setting unit may obtain the possible value of the variable to be used in the input program from a predetermined file, and may set the obtained possible value of a variable, on the node of the intermediate code.

According to still another aspect of the present invention, there is provided a program optimization method of optimizing an input program written in a programming language, the method including: converting the input program into an intermediate code; obtaining, from externally provided information, a possible value of a variable to be used in the input program, and setting the obtained possible value of the variable, on a node in a tree structure representing the intermediate code; optimizing the intermediate code according to the possible value of the node; and converting the intermediate code optimized by the intermediate code optimization unit into an output program written in a predetermined format.

It should be noted that the present invention can be embodied not only as a program optimization device provided with the characteristic processing units as described above or a program optimization method including processing units included in the device as steps but also as a program which causes a computer to executed the characteristic steps included in the program optimization method.

It should be understood that such a program can be distributed via a recording medium such as a CD-ROM (compact disc read only memory) and a communication network such as the Internet.

### EFFECTS OF THE INVENTION

According to the present invention, it is possible to present a program optimization device that performs optimization which depends on characteristics of data to be processed through execution of a program and which does not require execution of the program prior to the optimization.

Further, since a possible value of a variable in an input program is specified, it is also possible to generate an output program with a small program size, by using a value calculated from the possible value of the variable to replace the variable with a constant in the case where a result of the calculation is invariably a fixed value or to delete a redundant branch.

Furthermore, since a possible value of a variable in the input program is specified, it is also possible to increase the number of replacement to a constant with a small number of branches by using the value calculated from the possible value, thereby enhancing the possibility of higher execution speed.

### BRIEF DESCRIPTION OF DRAWINGS

FIG. 1 is a diagram which shows a program optimization device according to an embodiment of the present invention.

FIG. 2 is a flow chart of processing performed by the program optimization device according to an embodiment of the present invention.

FIG. 3 is a diagram which shows an example of an input program.

FIG. 4 is a diagram which shows an example of an intermediate code.

FIG. 5 is a diagram which shows the intermediate code and a possible value of each node included in the intermediate code which are shown in FIG. 4.

FIG. 6 is a diagram which shows an example of dependency information of data.

FIG. 7 is a diagram which shows a set of constants which are the result of calculation performed by a node value calculation unit.

FIG. 8 is a diagram for explaining an example of a first conversion performed by an intermediate code optimization unit.

FIG. 9 is a diagram for explaining an example of a third conversion performed by the intermediate code optimization unit.

FIG. 10 is a diagram which shows an output program converted from the input program shown in FIG. 3 according to an embodiment of the present invention.

FIG. 11 is a diagram which shows an output program converted from the input program shown in FIG. 3 according to a conventional technique.

FIG. 12 is a diagram which shows a modification of the program optimization device.

FIG. 13 is a diagram which shows an example of an input program.

FIG. 14 is a diagram which shows an example of a specification file.

FIG. 15 is a diagram which shows a modification of the program optimization device.

FIG. 16 is a diagram which shows an example of a GUI.

FIG. 17 is a diagram which shows an example of the GUI.

### NUMERICAL REFERENCES

101, 101a, 101b program optimization device
111 input program
112 output program
113 specification file
114 display terminal
121 intermediate code conversion unit
122, 122a, 122b variable value setting unit
123 node value calculation unit
124 intermediate code optimization unit
125 output program conversion unit
131 intermediate code

### BEST MODE FOR CARRYING OUT THE INVENTION

A program optimization device according to an embodiment of the present invention will be described below with reference to the drawings.

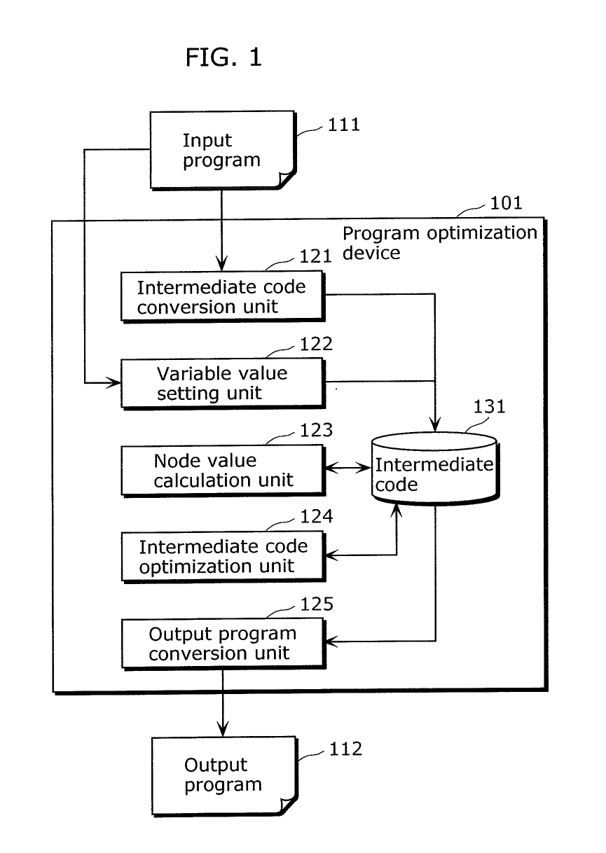

First, a configuration of the program optimization device will be described with reference to FIG. 1.

A program optimization device 101 is a device that converts an input program 111 in which a program to be optimized is written, into an output program 112 that is an optimized program. The program optimization device 101 includes: an intermediate code conversion unit 121; a variable value setting unit 122; a node value calculation unit 123; an intermediate code optimization unit 124; and an output program conversion unit 125. The program optimization device 101 is implemented by executing, on a general computer including a processor and a memory, a program that implements each processing unit. It is to be noted that, a program, a code, data, and so on which are used in processing performed by the program optimization device 101 are temporally stored on a memory or the like on a computer.

The intermediate code conversion unit 121 converts the input program 111 into an intermediate code 131.

The input program 111 is written in existing programming languages such as C language. The intermediate code 131 represents the content of the input program 111 in an existing expression form of programs such as abstract syntax tree.

The variable value setting unit 122 sets, on the intermediate code 131, a possible value of a variable written in the input program 111, as a set of constants. The possible value of the variable can be specified by writing a directive such as a pragma on the input program 111. In addition, it can also be specified by writing information indicating a possible value of a variable on a file that is different from the input program. Further, it can also be specified on the input program by a user input using a graphical user interface (GUI). It is to be noted that, the GUI does not necessarily need to be used in the user input, but other interfaces may be used for receiving the user input.

The node value calculation unit 123 calculates a possible value of each node in a tree structure representing the intermediate code 131 based on the set of constants for the variable determined by the variable value setting unit 122.

The intermediate code optimization unit 124 converts the intermediate code according to one of three conversion methods described below, based on the possible value of each node of the intermediate code 131 calculated by the node value calculation unit 123.

The first conversion method is, in the case where there is only one possible value of a node, a method of replacing the node with a constant node that represents the possible value of the node.

The second conversion method is, in the case where a node represents a conditional branch, a method of deleting, from an intermediate code, a conditional branch based on a value that is not included in a possible value of the node.

The third conversion method is a method of generating branches for the number of elements of set of a constant, and replacing the node with a constant node at each of the branches in the same manner as the first conversion.

The output program conversion unit 125 converts the optimized intermediate code 131 into an output program 112 written in a predetermined format.

The format of the output program 112 includes, for example, C language, assembly language, machine language, and the like in the case where the program optimization device 101 is used as a C compiler, and Verilog language and the like in the case where the program optimization device 101 is used as a high-level synthesis tool.

Next, the processing performed by the program optimization device 101 will be explained.

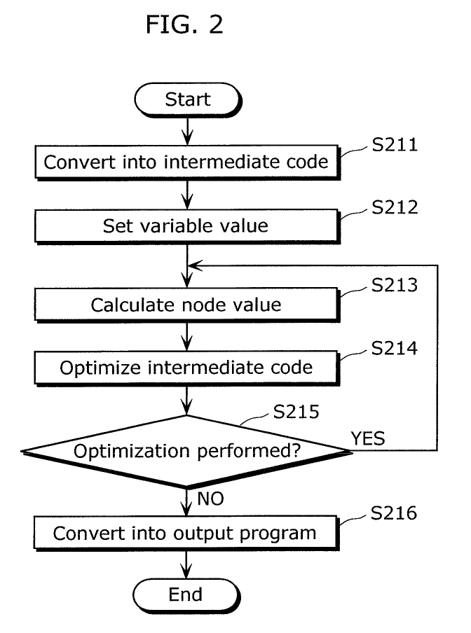

FIG. 2 is a flowchart of the processing performed by the program optimization device.

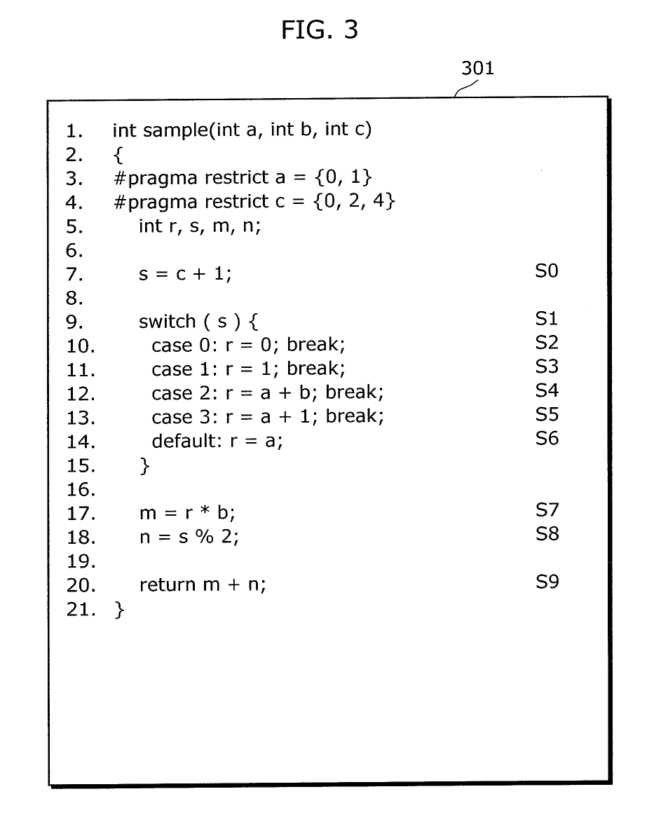

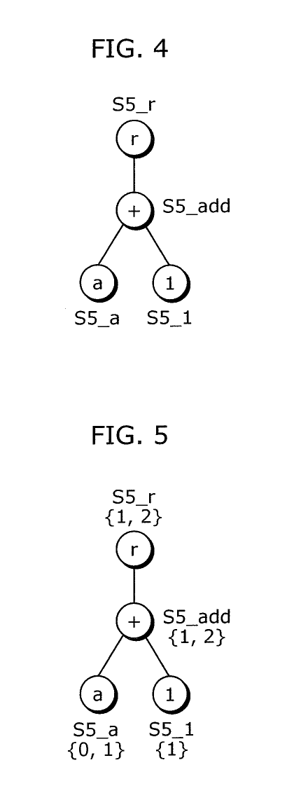

The intermediate code conversion unit 121 converts the input program 111 into an intermediate code 131 (S211). FIG. 3 is a diagram which shows an example of an input program. FIG. 4 is a diagram which shows an example of the intermediate code 131. The diagram shows an intermediate code that is obtained as a result of converting a statement S5 on the line 13 of the input program 301 shown in FIG. 3. The intermediate code is represented in a tree structure that includes: nodes S5_a and S5_r which indicate a reference of a variable; a node S5_1 that indicates a constant; and a node S5_add that indicates an arithmetic operation.

Next, the variable value setting unit 122 sets, on the node that indicates a reference of a variable (a reference node of a variable), a set of constants that indicate possible values of the variable (S212). The pragma directives on the line 3 and the line 4 of the input program 301 as shown in FIG. 3 are directives that specifies possible values of a variable a are {0, 1} and possible values of a variable c are {0, 2, 4}, respectively. In this case, the variable value setting unit 122 obtains the possible value of the variable from the pragma directive of the input program 111 and sets a set of constants {0, 1} for the node that refers to the variable a. In the same manner, a set of constant {0, 2, 4} is set for the node that refers to the variable c.

Next, the node value calculation unit 123 calculates a set of constants that indicate possible values of the node that is included in the intermediate code 131 (S213). For example, the intermediate code shown in FIG. 4 is examined. FIG. 5 is a diagram which shows the intermediate code and a possible value of each node included in the intermediate code which are shown in FIG. 4. As shown in the diagram, a set of constants {0, 1} has been set on the node S5_a that indicates a reference of the variable a, in accordance with the pragma directive on the line 3 of the input program 301 as shown in FIG. 3. Further, “1” is the only possible value for the constant node S5_1. Thus, the node value calculation unit 123 calculates a constant set {1} as the possible value of the constant node S5_1. In an add-operation node S5_add, a value of the node S5_a and a value of the node S5_1 both of which are operands are added. Thus, the node value calculation unit 123 determines the set of constants that indicates possible values of the add-operation node S5_add as {1, 2} by using the set of constants {0, 1} that indicates possible values of the node S5_a and the set of constants {1} that indicates possible values of the node S5_1. In addition, the node value calculation unit 123 determines the set of constants of the node S5_r that indicates the reference of a variable r as {1, 2} that is the same as the set of constants that indicate possible values taken by the add-operation node S5_add.

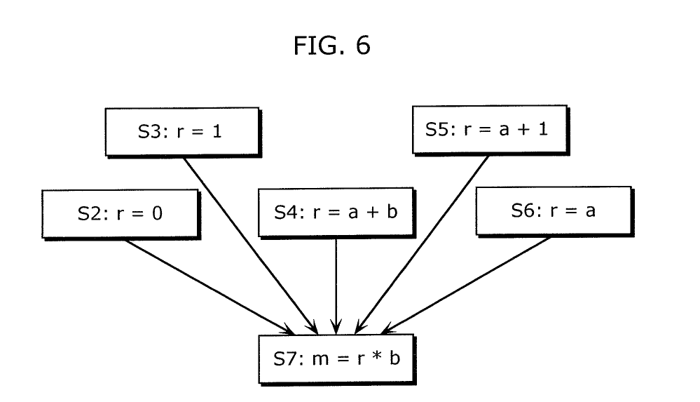

Further, the node value calculation unit 123 propagates the set of constants according to data dependency information, in the same manner as constant propagation that is a general optimization method. For example, the variable r that is defined in lines 10 to 14 of the input program 301 as shown in FIG. 3 is used in the line 17. In this case, the data dependency information between the statement nodes S2 to S6 which respectively correspond to the lines 10 to 14 and the statement node S7 corresponding to the line 17 is represented as a graph from a dependency source to dependency destination as shown in FIG. 6. More specifically, the statement nodes S2 to S6 that define the variable r represent the dependency source, and the statement node S7 that refers to the variable r represents the dependency destination. The node value calculation unit 123 calculates the set of constants of the statement node S7 based on the set of constants of the statement nodes S2 to S6 by using the data dependency information. More specifically, the node value calculation unit 123 calculates the set of constants of the dependency destination as a union of the set of constants of the dependency source by using the data dependency information. As a result, the set of constants of the reference node S7_r of the variable r in the statement node 57 is calculated.

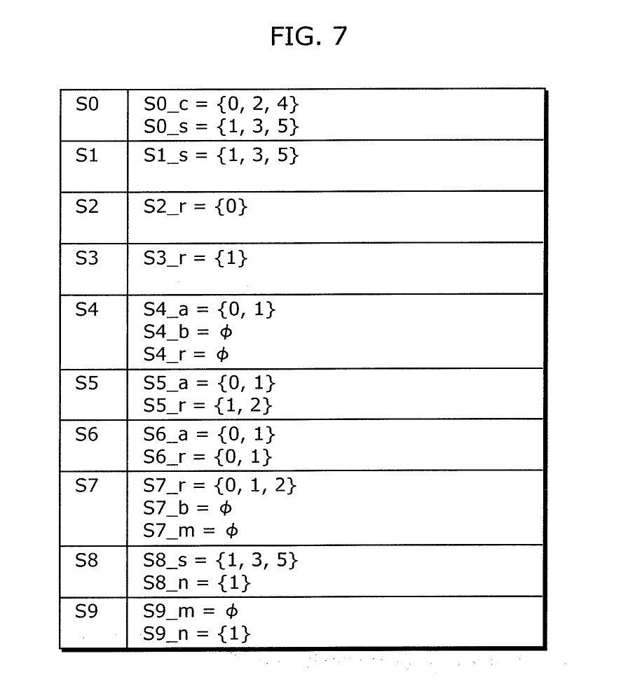

The set of constants that indicates a possible value of a node is calculated for all of the nodes in the same way, so that the set of constants is calculated for each of the nodes as shown in FIG. 7. FIG. 7 is a diagram which indicates a portion of a set of constants designated in the node included in the intermediate code 131. The set of constants designated in the node is the set that indicates a possible value of each of the nodes included in the intermediate code 131. An empty set φ is designated in a node of which the set of constants has not been calculated, which indicates that any value is possible.

Next, the intermediate code optimization unit 124 converts the intermediate code 131 by using the calculated set of constants of a node (S214). There are three conversion methods as described below, for converting the intermediate code 131.

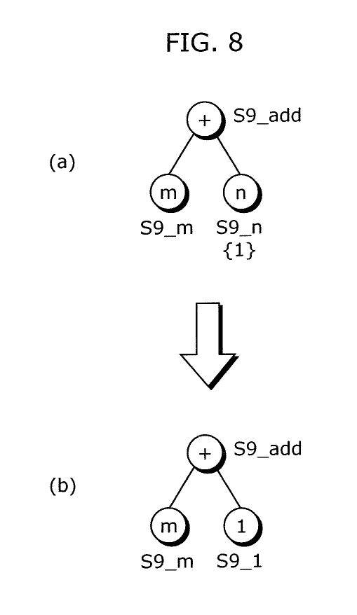

The first conversion is a conversion by which, in the case where the number of elements of the set of constants of a node is one, the node is replaced with a constant node that represents the element of the set. FIG. 8(a) is a diagram which shows an intermediate code before conversion in the statement node S9 of the input program 301. FIG. 8(b) is a diagram which shows an intermediate code after conversion in the statement node S9. The set of constants of a reference node S9_n of a variable n that has been calculated by the node value calculation unit 123 is {1} as shown in FIG. 7, and thus the number of elements is one. Thus, the intermediate code optimization unit 124 replaces the reference node S9_n of the variable n with a constant node S9_1 that represents a numerical value “1” that is the element. This replacement renders a statement node S8 a dead code. Thus, the intermediate code optimization unit 124 deletes the statement node S8 by performing optimization of the dead code elimination that is a general optimization method. This makes it possible to reduce the program size.

The second conversion is a conversion by which a branch depending on a value that is not included in a set of constants included in a node is deleted from the intermediate code. The set of constants included by the node S1_s that indicates a condition for branching of a branching statement node S1 of the input program 301 is {1, 3, 5} as shown in FIG. 7. A branch “case0” indicated by the statement node S2 is a conditional branch in the case where the value of the node S1_s is “0”. The node S1_s does not include an element “0” in the calculation result of the node value shown in FIG. 7. Thus, the statement S2 is not executed during executing the program. Therefore, the intermediate code optimization unit 124 deletes the branch “case0” indicated by the statement node S2. The intermediate code optimization unit 124 deletes a branch “case2” indicated by the statement node S4 in the same manner. This reduces the branches to branches including the statement nodes S3, S5, and S6 only as indicated by the output program 401. As a result of the replacement, it is obvious that the program size is reduced.

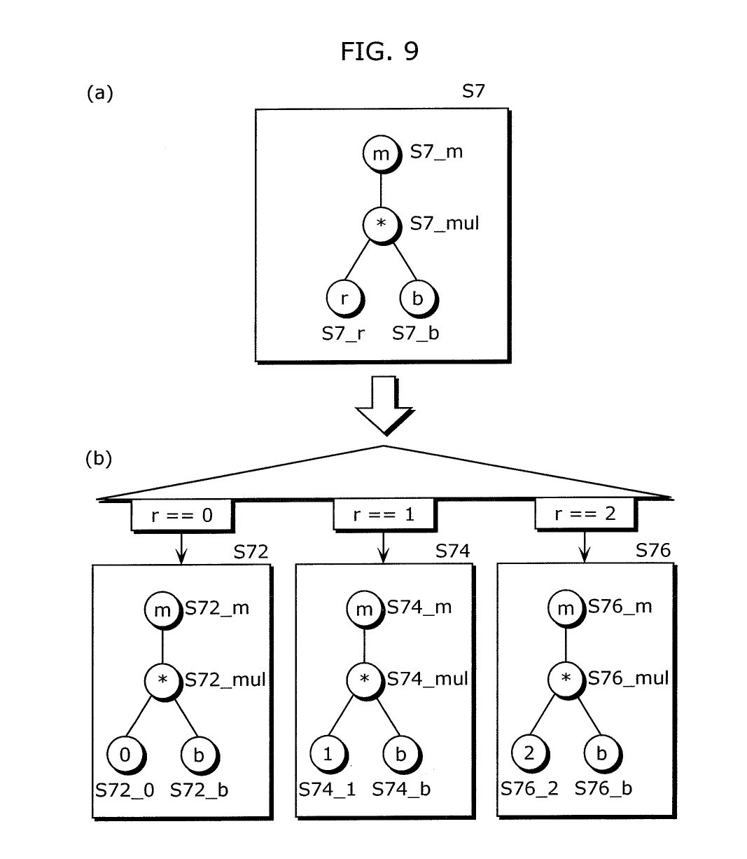

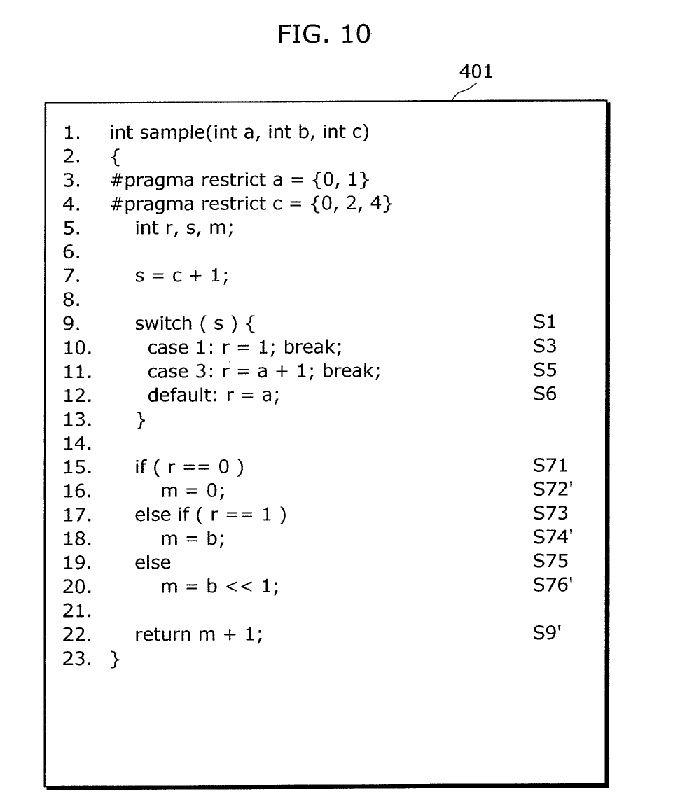

The third conversion is a conversion by which branches for the number of elements of the set of constants are generated and nodes are replaced with constant nodes in each of the branches in the same manner as the first conversion. FIG. 9(a) is a diagram which shows an intermediate code before conversion in the statement node S7 of the input program 301 shown in FIG. 3. FIG. 9(b) is a diagram which shows an intermediate code after conversion in the statement node S7. In the statement node S7, the set of constants of the reference node S7_r of the variable r is {0, 1, 2}. Thus, the intermediate code optimization unit 124 generates branches respectively corresponding to the constants 0, 1, and 2 as shown in FIG. 9(b). The intermediate code optimization unit 124 converts the intermediate code by replacing the reference node S7_r of the variable r with a constant node at each of the branches. The branches are indicated as the statement nodes S72, S74, and S76. The statement nodes S72, S74, and S76 are generated by reproducing the statement node S7 and replacing the node that corresponds to the reference node S7_r of the variable r with the constant nodes S72_0, S74_1, S76_2 which indicate the constants 0, 1, 2, respectively. This conversion enables, as a result, optimization such as constant folding or reduction in an operator strength which are conventional optimization methods. Ultimately, multiplication included in the statement node S7 is converted into another calculation, and the statement nodes S72, S74, and S76 are optimized into statement nodes S72′, S74′, and S76′, respectively, in the output program 401 shown in FIG. 10. In the case where shift operation can be executed at higher speed than multiplication at the time of execution of a program, it is possible to improve the program execution time using the third conversion. Further, in such a case as generating hardware using an output program, the multiplication device itself is unnecessary. Therefore, it is possible to reduce the size of hardware.

In the third conversion, branches for the number of elements are newly generated. For that reason, execution of the third conversion may be restricted. For example, the third conversion may be executed only for an element of which the conversion enables constant folding. Further, the third conversion may be executed by limiting to the case where calculation such as multiplication or division of which the operator strength can be reduced by the conversion is included.

Next, the program optimization device 101 determines whether or not the intermediate code is converted (S215), and in the case where the intermediate code is converted (YES in S215), processing subsequent to the node value calculation processing (S213) is performed again to obtain further optimization.

In the case where the intermediate code is not converted (No in S215), the output program conversion unit 125 generates, from the intermediate code 131 that has been optimized by the intermediate code optimization unit 124, an output program 112 written in a predetermined format (S216).

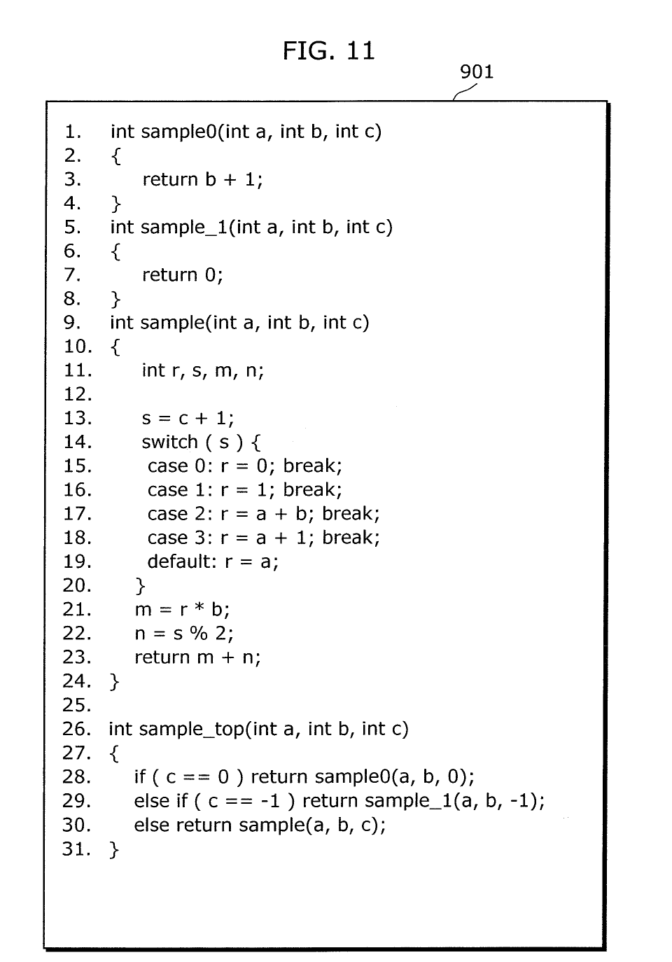

FIG. 10 shows the output program that has been optimized from the input program 301 by the program optimization device 101. FIG. 11 shows an example of an output program that has been optimized from the input program 301 by using a conventional technique. In FIG. 11, the optimization is performed by specializing in the case where a variable takes a specific value. FIG. 10 and FIG. 11 clearly show that the output program generated by the program optimization device 101 has a program size smaller than the output program generated using the conventional technique.

According to the embodiment of the present invention as described above, a possible value of a variable used in an input program is obtained in advance, and an intermediate code is optimized based on the value. The above structure allows optimization that depends on characteristics of data to be processed with execution of a program without executing the program before optimization. Further, it is possible to reduce dead codes by performing optimization using information on the value that the variable never takes. Thus, it is possible to generate a code with the program size smaller than that obtained through optimization using the conventional technique.

Further, since a possible value of a variable in an input program is specified, it is also possible to generate an output program with a small program size, by using a value calculated from the possible value of the variable to replace the variable with a constant in the case where a result of the calculation is invariably a fixed value or to delete a redundant branch.

Furthermore, since a possible value of the variable in the input program is specified, it is also possible to increase the number of replacement to a constant with a small number of branches by using the value calculated from the possible value, thereby enhancing the possibility of higher execution speed.

The program optimization device 101 according to the embodiment of the present invention has been described above, however, the present invention is not limited to the above embodiment.

For example, in the above-described method according to the embodiment, the input program 111 has been written in C language and a possible value of a variable is specified by the pragma directive. However, the possible value of the variable may also be specified by writing the same information as the information specified by the pragma directive in a file that is different from the input program.

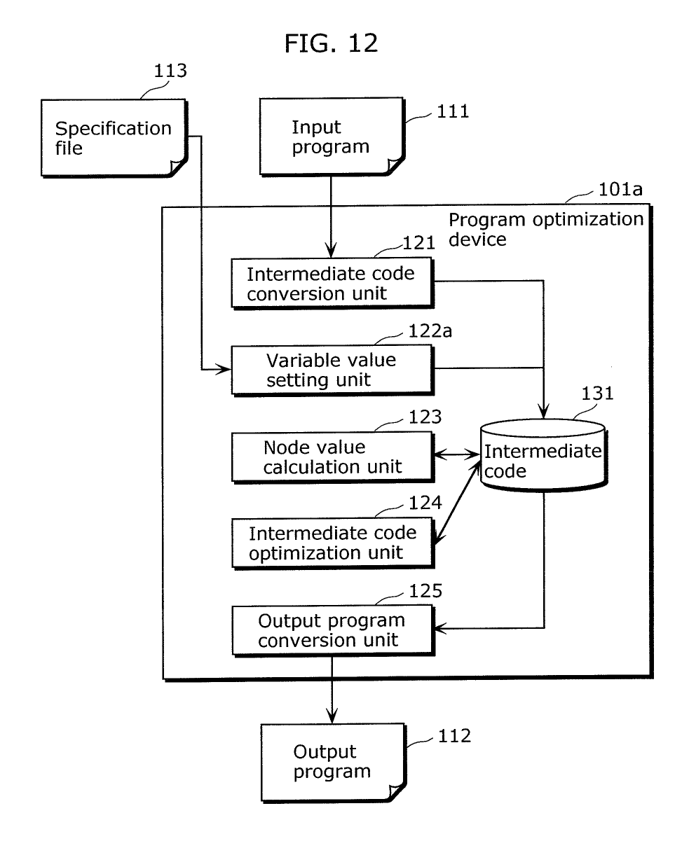

The following describes a method for specifying a possible value of a variable by using a specification file that is different from the input program with reference to FIG. 12 to FIG. 14.

FIG. 12 is a diagram which shows a configuration of a program optimization device according to this method. In a program optimization device 101a, the variable value setting unit 122 of the program optimization device 101 shown in FIG. 1 is replaced with a variable value setting unit 122a. Other than that, the program optimization device 101a has the same configuration as the program optimization device 101. A variable value setting unit 122a obtains a possible value of a variable from a specification file 113, and sets the possible value of the variable on an intermediate code 131 as a set of constants.

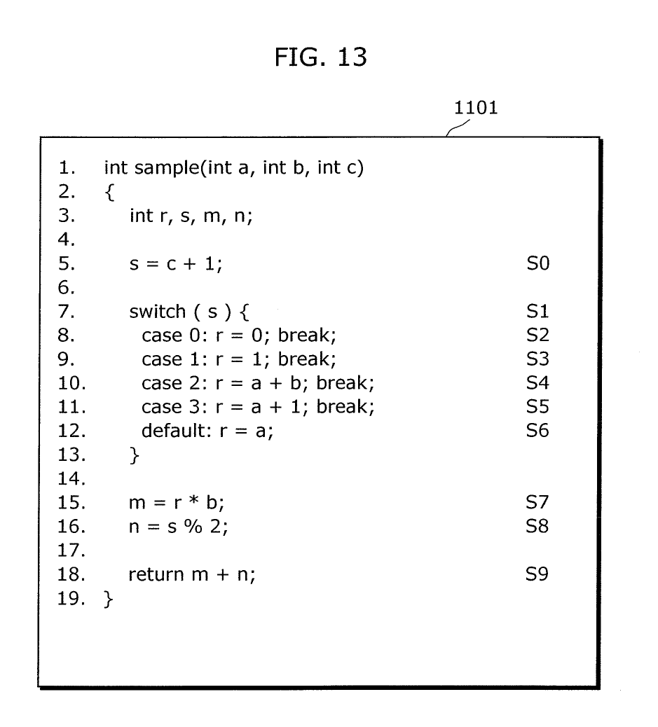

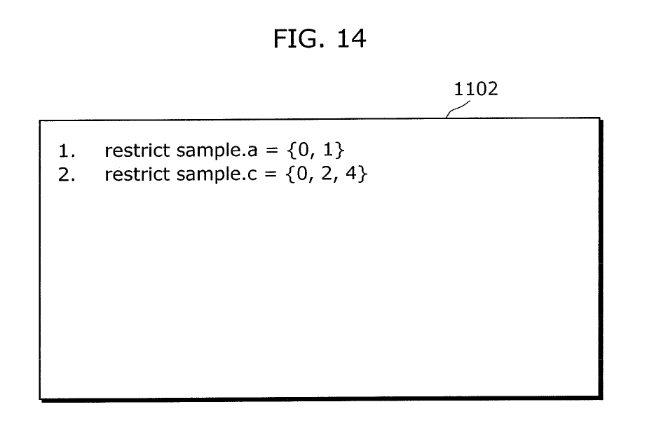

FIG. 13 is a diagram which shows an example of an input program. FIG. 14 is a diagram which shows an example of a specification file. In the case where possible values of variables are specified for variables a and c written in an input program 1101, for example, the possible values of the variables a and c can be specified by writing, on a specification file 1102, information that identifies the variables a and c and the possible values of the variables a and c in the same manner as the pragma directive.

It is to be noted that, in addition to specifying a possible value of a variable by using the pragma directive or the specification file, it may also be possible to display an input program on a screen and input, by using the GUI, a possible value of a variable for the variable that is specified by a user with a pointer.

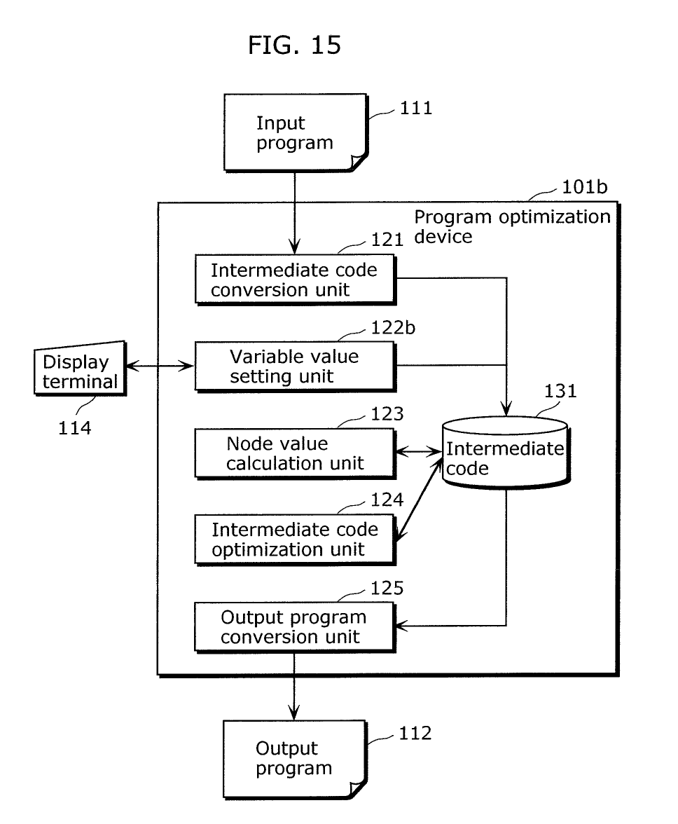

The following describes with reference to FIG. 15 to FIG. 17, a method for specifying a possible value of a variable by using a GUI.

FIG. 15 is a diagram which shows a configuration of a program optimization device according to this method. In a program optimization device 101b, the variable value setting unit 122 of the program optimization device 101 shown in FIG. 1 is replaced with a variable value setting unit 122b. Other than that, the program optimization device 101b has the same configuration as the program optimization device 101. The variable value setting unit 122b displays the input program 111 on a display terminal 114, obtains a possible value of a variable with an input by a user, and set the possible value of the variable on an intermediate code 131 as a set of the variable.

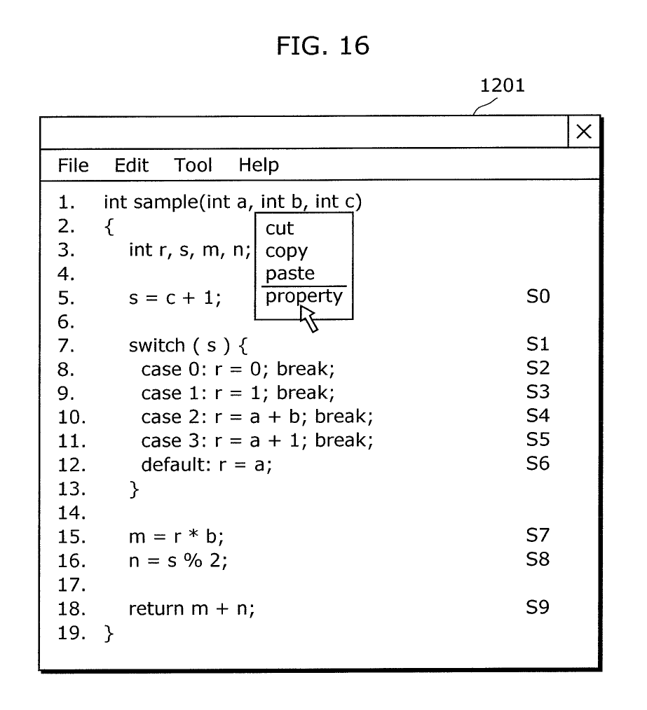

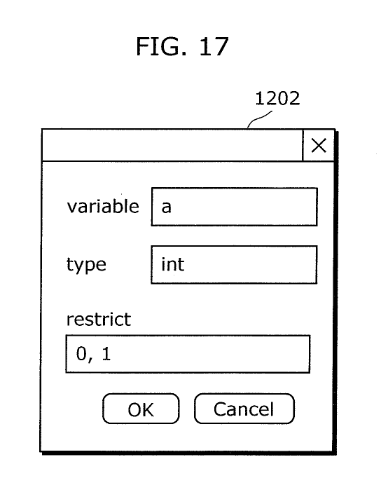

FIG. 16 is a diagram which shows an example of an input program display window which is displayed on the display terminal 114 and includes an input program. FIG. 17 is a diagram which shows an example of a variable attributes dialog. The case where a possible value of a variable is specified for the variable a written in an input program that is displayed on an input program display window 1201 is considered, for example. A user selects the variable a using a pointer on the input program display window 1201. Next, the user selects a menu to open the variable attributes dialog 1202 from a pull down menu, so that the variable attributes dialog 1202 is displayed on the display terminal 114. The user inputs “0, 1” as possible values of the variable a in the variable attributes dialog 1202. Likewise, a possible value is inputted for the variable c, thereby allowing specifying the possible values of the variables a and c in the same manner as the pragma directive.

It is to be noted that, it is also possible that a user inputs possible value of a variable by not using the GUI but by using a character user interface (CUI), for example.

It is to be understood that all of the embodiments disclosed here is for purposes of illustration and not limitation in all respects. The scope of the present invention is indicated not by the above-described description, but by claims, and includes all modifications within the meaning and scope equivalent to the claims.

### INDUSTRIAL APPLICABILITY

The program optimization device according to the present invention can be applied to a compiler that generates an object code from a source code of a program and a high-level synthesis tool that generates a register transfer level (RTL) description from a sequential processing program, and is in particular useful in the case of generating an object code or an RTL description on which optimization depending on data to be processed by a program has been performed.

1. A program optimization device which optimizes an input program written in a programming language, said device comprising:
an intermediate code conversion unit configured to convert the input program into an intermediate code;
a variable value setting unit configured to obtain, from externally provided information, a possible value of a variable to be used in the input program, and to set the obtained possible value of the variable, on the intermediate code;
an intermediate code optimization unit configured to optimize the intermediate code according to the set possible value of the variable; and
an output program conversion unit configured to convert the intermediate code optimized by said intermediate code optimization unit into an output program written in a predetermined format.

2. The program optimization device according to claim 1,
wherein said variable value setting unit is configured to obtain the possible value of the variable to be used in the input program with an input by a user, and to set the obtained possible value of the variable, on the intermediate code.

3. The program optimization device according to claim 1,
wherein said variable value setting unit is configured to obtain the possible value of the variable to be used in the input program from a directive written in the input program, and to set the obtained possible value of the variable, on the intermediate code.

4. The program optimization device according to claim 1,
wherein said variable value setting unit is configured to obtain the possible value of the variable to be used in the input program from a predetermined file, and to set the obtained possible value of a variable on the intermediate code.

5. The program optimization device according to claim 1,
wherein, when the intermediate code is represented in a tree structure, said intermediate code optimization unit is configured to replace a node that has only one possible value among a plurality of nodes included in the intermediate code, with a node that indicates a constant.

6. The program optimization device according to claim 1,
wherein, when the intermediate code is represented in a tree structure, said intermediate code optimization unit is configured to delete, from the intermediate code, a branch depending on a value not included in the possible value of the node that represents a conditional branch.

7. The program optimization device according to claim 1,
wherein, when the intermediate code is represented in a tree structure, said intermediate code optimization unit, is configured to convert a node that includes a variable node indicating a variable that has a plurality of possible values into a plurality of nodes each of which includes the variable node that branches according to the possible value, and to replace the variable node included in each of the plurality of nodes resulting from the conversion, with a constant node that indicates the possible value used as a condition for branching.

8. The program optimization device according to claim 1,
wherein, when the intermediate code is represented in a tree structure, said intermediate code optimization unit is configured to calculate a possible value of a node from the possible value of the variable, and to optimize the intermediate code according to the possible value of the node.

9. A program optimization device which optimizes an input program written in a programming language, said device comprising:
an intermediate code conversion unit configured to convert the input program into an intermediate code;
a variable value setting unit configured to obtain, from externally provided information, a possible value of a variable to be used in the input program, and to set the obtained possible value of the variable, on a node in a tree structure representing the intermediate code;
an intermediate code optimization unit configured to optimize the intermediate code according to the possible value of the node; and
an output program conversion unit configured to convert the intermediate code optimized by said intermediate code optimization unit into an output program written in a predetermined format.

10. The program optimization device according to claim 9,
wherein, when the intermediate code is represented in the tree structure, said intermediate code optimization unit is configured to replace a node that has only one possible value among a plurality of nodes included in the intermediate code, with a node that indicates a constant.

11. The program optimization device according to claim 9,
wherein, when the intermediate code is represented in the tree structure, said intermediate code optimization unit is configured to delete, from the intermediate code, a branch depending on a value not included in a possible value of the node that represents a conditional branch.

12. The program optimization device according to claim 9,
wherein said intermediate code optimization unit, when the intermediate code is represented in the tree structure, is configured to convert a node that includes a variable node indicating a variable that has a plurality of possible values into a plurality of nodes each of which includes the variable node that branches according to a possible value, and to replace the variable node included in each of the plurality of nodes resulting from the conversion, with a constant node that indicates the possible value used as the a condition for branching.

13. The program optimization device according to claim 9,
wherein said variable value setting unit is configured to obtain the possible value of the variable to be used in the input program with an input by a user, and to set the obtained possible value of a variable, on the node of the intermediate code.

14. The program optimization device according to claim 9,
wherein said variable value setting unit is configured to obtain the possible value of the variable to be used in the input program from a directive written in the input program, and to set the obtained possible value of the variable, on the node of the intermediate code.

15. The program optimization device according to claim 9,
wherein said variable value setting unit is configured to obtain the possible value of the variable to be used in the input program from a predetermined file, and to set the obtained possible value of a variable, on the node of the intermediate code.

16. A program optimization method of optimizing an input program written in a programming language, said method comprising:
converting the input program into an intermediate code;
obtaining, from externally provided information, a possible value of a variable to be used in the input program, and setting the obtained possible value of the variable, on a node in a tree structure representing the intermediate code;
optimizing the intermediate code according to the possible value of the node; and
converting the intermediate code optimized in said optimizing, into an output program written in a predetermined format.
